(19) United States
(12) Patent Application Publication
(10) Pub. No.: US 2024/0205896 A1
(43) Pub. Date: Jun. 20, 2024

(54) SYSTEMS AND METHODS FOR ALLOCATING AND POSITIONING USER EQUIPMENT IN PRIVATE NETWORKS BASED ON RADIO FREQUENCY TRANSMIT CHARACTERISTICS

(71) Applicant: Verizon Patent and Licensing Inc., Basking Ridge, NJ (US)

(72) Inventors: Sylvestre DEMONGET, Millburn, NJ (US); David Albert ROSSETTI, Randolph, NJ (US); Anand J. SHAH, Parsippany, NJ (US); Madhusudan Mandyam BHEEMARAYAN, Hillsborough, NJ (US)

(73) Assignee: Verizon Patent and Licensing Inc., Basking Ridge, NJ (US)

(21) Appl. No.: 18/068,956

(22) Filed: Dec. 20, 2022

(51) Int. Cl. H04W 72/0453; H04W 72/044; H04W 72/51

(52) U.S. Cl. CPC H04W 72/0453; H04W 72/0473; H04W 72/51

(57) ABSTRACT

A device may receive user equipment (UE) data identifying a UE and a location of the UE, network data identifying base stations and locations of the base stations associated with the UE, and radio frequency transmit characteristics of the UE. The device may calculate a signal range of the UE based on the UE data, the network data, and the radio frequency transmit characteristics of the UE. The device may process the UE data, the network data, the signal range of the UE, and triggers, with a model, to determine that the radio frequency transmit characteristics of the UE should be modified. The device may cause the UE to modify the radio frequency transmit characteristics of the UE based on the model determining that the radio frequency transmit characteristics of the UE should be modified.

### BACKGROUND

User equipment (UE) power classes defined by the 3GPP for New Radio (NR) specify requirements for certain radio frequency (RF) attributes of UEs for different frequency bands. A UE with a given UE power class shall meet these 3GPP requirements, although in practice some UEs will substantially exceed them based on more stringent RF requirements from network operators or the like.

### BRIEF DESCRIPTION OF THE DRAWINGS

FIGS. 1A-1G are diagrams of an example associated with allocating and positioning a UE in a private network based on radio frequency (RF) transmit characteristics of the UE.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIGS. 5 and 6 are flowcharts of example processes for allocating and positioning a UE in a private network based on RF transmit characteristics. FIG. 5 shows an example process for changing the RF characteristics of a UE. FIG. 6 shows a more generic example process with additional detail for allocating another UE with different RF characteristics, switching the RF transmit characteristics of an existing UE, and/or repositioning a UE.

### DETAILED DESCRIPTION OF EXAMPLE EMBODIMENTS

The following detailed description of example implementations refers to the accompanying drawings. The same reference numbers in different drawings may identify the same or similar elements.

Standard RF requirements of a UE power class include a minimum equivalent isotropic radiated power (EIRP) at a peak transmit angle, a maximum total radiated power (TRP), a maximum effective isotropic sensitivity (EIS) at a peak receive angle, and/or the like. In practice, some UEs compliant with a given power class will substantially exceed these requirements. It is thus beneficial to know not only the UE power class of a UE, but also actual RF characteristics of the UE, which may be obtained from RF conformance tests for the particular UE model. This may enable the design of purpose-built networks, such as a private network for industrial applications, and may provide diversity in UE RF characteristics available across different types of UEs for more efficient operation of such networks (e.g., which include complex topologies and diverse quality of service (QOS) requirements).

Current techniques for managing UEs in a private network (e.g., in a factory with robotic equipment) include managing UEs that are compliant with only one UE power class. However, a UE in a private network may experience poor network conditions due to movement of the UE within the private network, temporary obstructions blocking the signal between the UE and the base stations, and/or the like. In such situations, a trial-and-error approach may be utilized to relocate the UE to a location where the UE is receiving a satisfactory signal (e.g., satisfies QoS requirements). Such guesswork is time consuming and costly. Thus, current techniques for managing UEs in private networks consume computing resources (e.g., processing resources, memory resources, communication resources, and/or the like), networking resources, and/or other resources associated with failing to receive or transmit valuable data from or to the UE due to poor communication with the network resulting from incorrectly positioning a UE, creating interference for other UEs based on incorrectly positioning the UE, retransmitting data from or to the UE that is lost, and/or the like.

Some implementations described herein provide a management system that allocates a UE with certain RF transmit characteristics or cause the UE to change its RF transmit characteristics, and positions the UE in a private network based on RF transmit characteristics. For example, the management system may receive UE data identifying a UE and a location of the UE, network data identifying base stations and locations of the base stations associated with the UE, and RF transmit characteristics of the UE. The management system may calculate a signal range of the UE based on the UE data, the network data, and the RF transmit characteristics of the UE. The management system may process the UE data, the network data, the signal range of the UE, and triggers, with a model (e.g., a model based on deterministic algorithms, machine learning, and/or a combination of such approaches), to determine whether the RF transmit characteristics of the UE should be modified. In some implementations, the management system may cause the UE to modify its RF transmit characteristics based on the model determining that the RF transmit characteristics of the UE should be modified.

In this way, the management system allocates and positions a UE in a private network based on RF transmit characteristics. For example, the management system may allocate a UE with different power classes in private networks, enterprise networks, industrial networks, and/or the like. For added flexibility, the management system may manage a connected host device that embeds multiple UEs with different RF characteristics, or an evolved type of UE with a hardware design that is natively compliant with two or more UE power classes. The management system may generate a programing and user interface that provides a representation of a signal range of a UE in relation to network devices (e.g., base stations). The management system may allocate another UE with different RF transmit characteristics, modify RF transmit characteristics of the UE, and/or relocate and reposition a UE based on the signal range of the UE, application needs, uplink (UL) interference at the base station receiver associated with the UE, proximity of the UE to humans, and/or the like. Thus, the management system may conserve computing resources, networking resources, and/or other resources that would have otherwise been consumed by failing to receive valuable data from the UE due to poor communication with a network.

The management system provides new possibilities for purpose-built networks (e.g., private networks for smart industries) by enabling the use of UEs with more specialized RF characteristics. This is made possible by automatically allocating a correct type of UE and positioning the UE appropriately to fulfill a specific use case and associated quality of service (QoS) requirements within a complex and changing three-dimensional network setup. For example, enterprises may utilize higher power and/or directional antenna pattern devices, since the management system enables reorienting such devices in case a line of sight to an originally assigned base station (e.g., gNodeB or gNB) becomes obstructed, or switching such devices to a UE power class with lower EIRP if humans are in close proximity to be compliant with health-related RF emission rules. Compared to the legacy approach of using general-purpose UEs which tend to have lower transmit power and omnidirectional coverage, the management system may enable an enterprise to further utilize UE capabilities and increase the operational efficiency of a private network (e.g., fewer devices are needed, higher QoS performance is provided, and a higher level of reliability is provided).

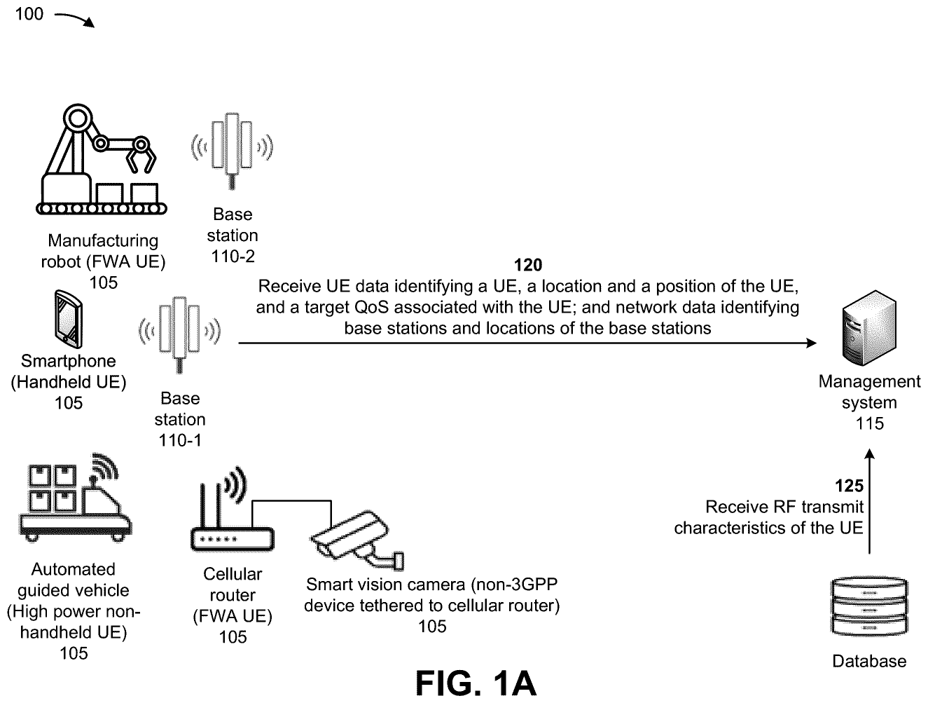

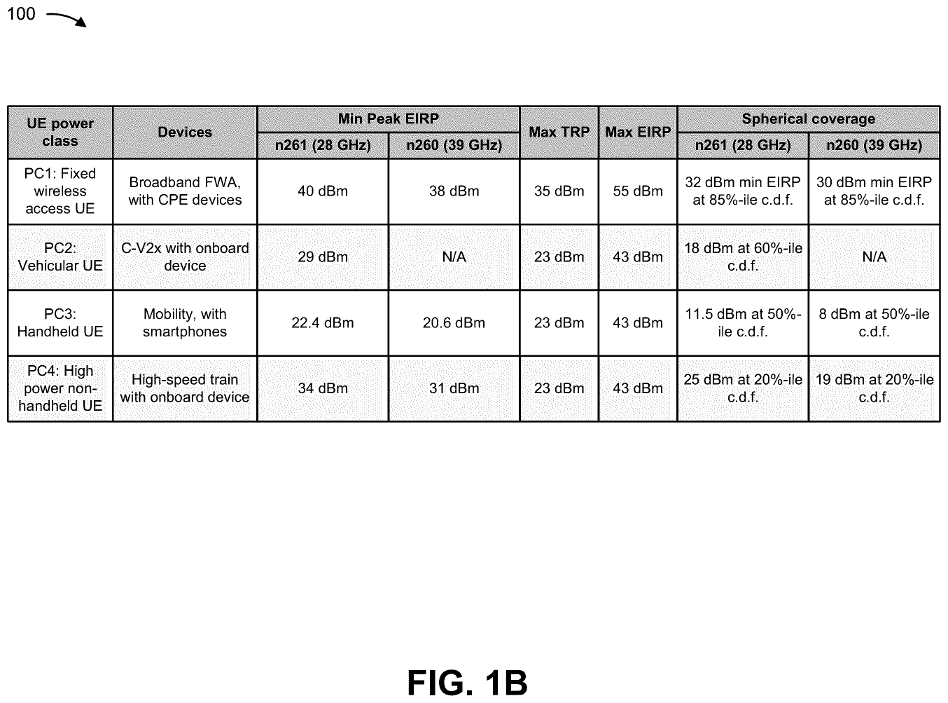

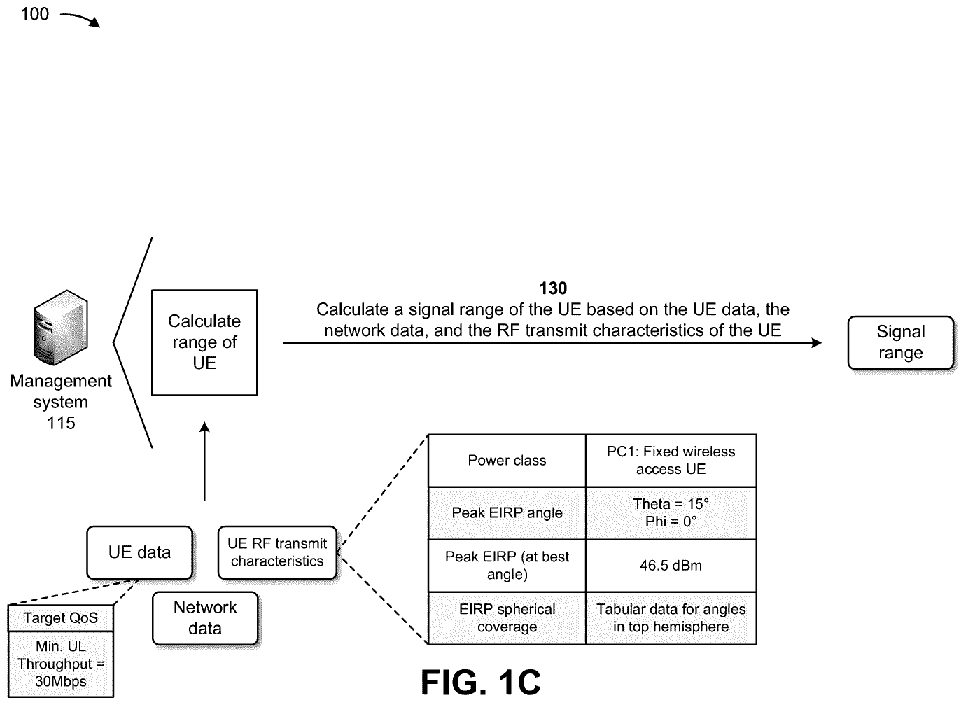

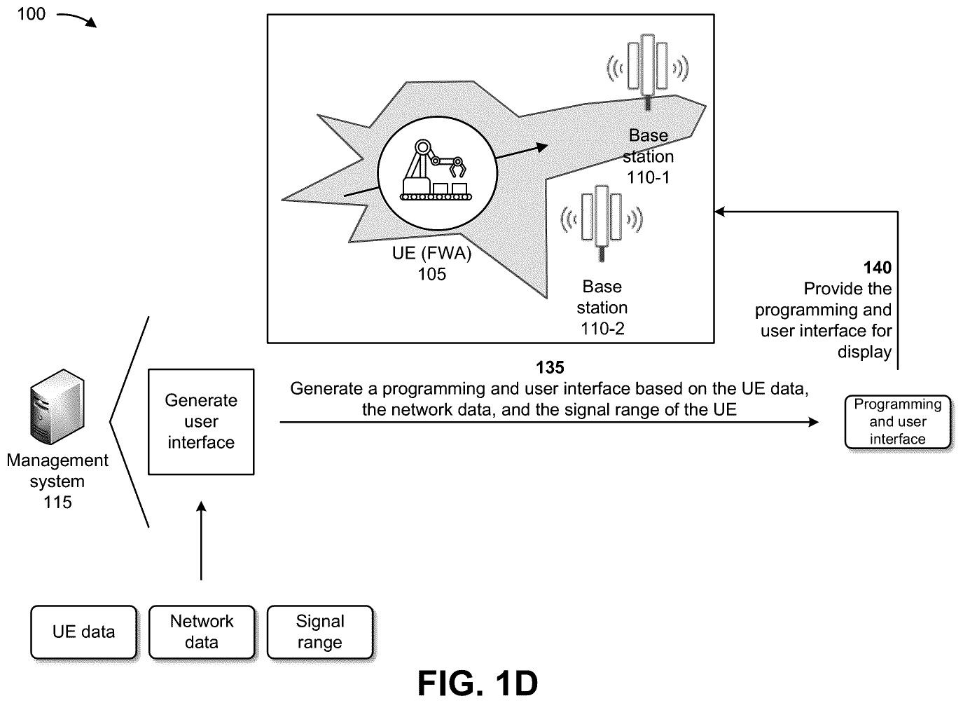

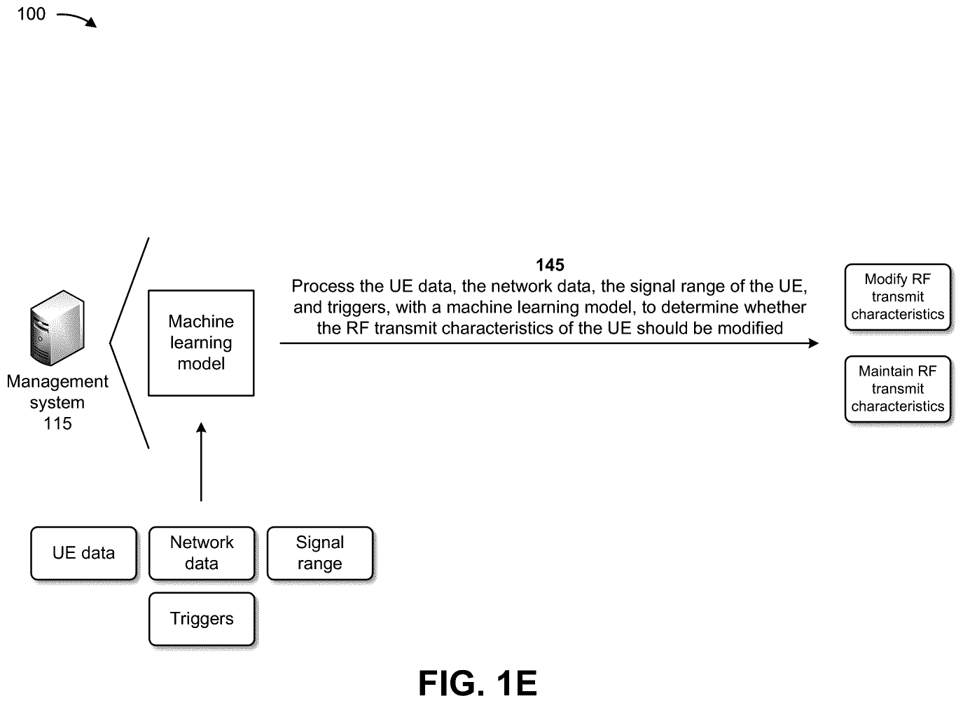

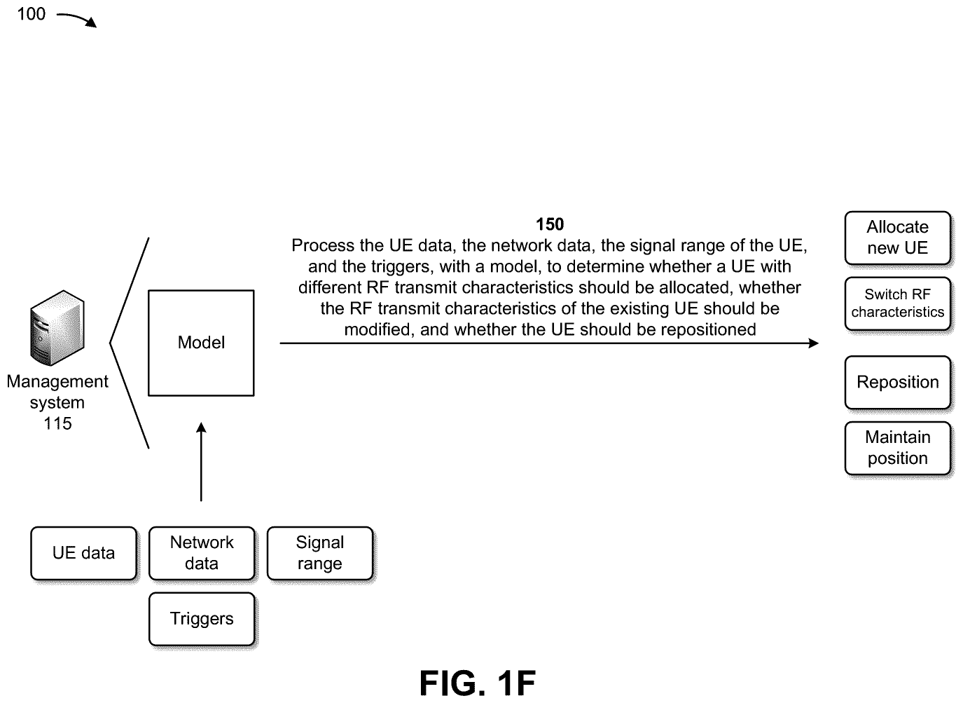

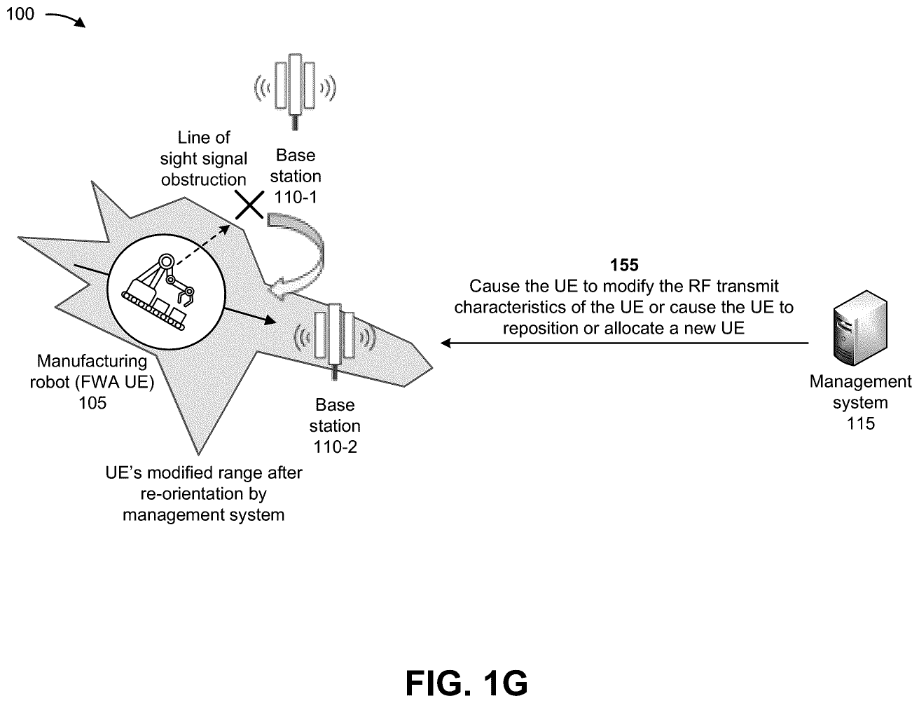

FIGS. 1A-1G are diagrams of an example 100 associated with allocating and positioning a UE in a private network based on RF transmit characteristics. As shown in FIGS. 1A-1G, example 100 includes a plurality of UEs 105 and base stations 110 (e.g., a first base station 110-1 and a second base station 110-2) associated with a management system 115. The UEs 105 may include different types of UEs, such as a manufacturing robot UE 105, a smartphone UE 105, an automated guided vehicle (AGV) UE 105, and a cellular router UE 105 used to provide connectivity to a non-3GPP device (e.g., a smart vision camera without a cellular modem). The different types of UEs 105 may be associated with one or more UE power classes, as shown in parenthesis of the UE labels in FIG. 1A and described below. Further details of the UEs 105, the base stations 110, and the management system 115 are provided elsewhere herein.

In some implementations, the management system 115 may allocate a device (e.g., a UE 105) with certain RF characteristics that is most suitable for a particular zone of a private network and for a particular purpose and/or QoS. For example, the management system 115 may select a UE 105 with the most suitable RF characteristics among a pool of UEs 105 available to an entity. For host devices embedding multiple UEs 105 with different UE power classes and/or RF characteristics or for UEs 105 with hardware designs that natively support multiple UE power classes and/or RF characteristics, the management system 115 may select and cause the UE 105 to switch to the most suitable set of RF characteristics. The management system 115 may also cause the UE 105 to be positioned in a most suitable way including precise coordinates and three-dimensional (3D) orientation (e.g., azimuth and tilt). The coordinates may be constrained in some cases, such as for a video surveillance camera or a robot arm on a conveyer belt, but in such cases the 3D orientation may still be manipulated. In some implementations, allocating may refer to selecting a UE 105 with particular RF characteristics that are most suitable for a particular zone of a private network and a particular use case with associated QoS targets. In some implementations, positioning may refer to determining precise coordinates and orientation of the UE 105, including azimuth and tilt angles.

As shown in FIG. 1A, and by reference number 120, the management system 115 may receive UE data identifying a UE 105 (e.g., the manufacturing robot UE 105 with fixed wireless access (FWA) UE power class), a location and a position of the UE 105, a target QoS associated with the UE 105, and network data identifying the base stations 110 and locations of the base stations 110. For example, the management system 115 may receive the UE data from the UE 105 and/or from the base stations (e.g., the first base station 110-1 and/or the second base station 110-2). The UE data may include data identifying the UE 105 (e.g., an International Mobile Subscriber Identity (IMSI), a Subscription Permanent Identifier (SUPI), a Subscription Concealed Identifier (SUCI), a mobile directory number (MDN), an international mobile equipment identity (IMEI), and/or the like), the location of the UE 105 (e.g., precise 2D or 3D coordinates obtained by a combination of mobile positioning techniques including global positioning system (GPS), NR positioning features (e.g., angle of arrival/departure), on-device sensors, etc.), whether the UE 105 is moving (e.g., based on real-time coordinates of the UE and/or an output of an on-device accelerometer), a target QoS (e.g., minimum uplink throughput, maximum latency, etc.) associated with the UE, and/or the like. The target QOS is driven by use cases and may be provided by the user of the management system 115 (e.g., an administrator of the private network), and a given target QoS may be associated with a particular UE or UEs within the private network setup. In some implementations, the target QoS may be changed dynamically by the system as part of a network slicing framework.

The management system 115 may receive the network data from the UE 105 and/or from the base stations 110 (e.g., the first base station 110-1 and/or the second base station 110-2). The network data may include data identifying the base stations 110, the coordinates and height of the antenna of the base stations 110, and known RAN capabilities of the base stations 110 such as the maximum uplink and downlink throughput, typical latencies, uplink signal-to-interference-and-noise ratio (SINR) at the receiver required to achieve a certain uplink throughput, maximum transmit power of the base station, and/or the like.

In some implementations, the management system 115 may continuously receive the UE data and the network data from the UE 105, the first base station 110-1, and/or the second base station 110-2; may periodically receive the UE data and the network data from the UE 105, the first base station 110-1, and/or the second base station 110-2; may receive the UE data and the network data from the UE 105, the first base station 110-1, and/or the second base station 110-2 based on providing a request for the UE data and the network data to the UE 105, the first base station 110-1, and/or the second base station 110-2; and/or the like.

As further shown in FIG. 1A, and by reference number 125, the management system 115 may receive RF transmit characteristics of the UE 105. For example, the management system 115 may receive multiple RF transmit characteristics of different UEs 105 from a source (e.g., a third-party server device or database) and may match the UE 105 with one of the multiple RF transmit characteristics based on the UE data (e.g., based on an identifier of the UE 105). In some implementations, the UE 105 may provide a power class of the UE 105 to the first base station 110-1 or the second base station 110-2 via a UE-PowerClass information element included in a radio resource control (RRC) UE capability information message. The first base station 110-1 or the second base station 110-2 may provide the power class of the UE 105 to the management system 115, and the management system 115 may utilize the power class of the UE 105 to identify the RF transmit characteristics of the UE 105 from the multiple RF transmit characteristics.

The RF transmit characteristics of the UE 105 may include data identifying the power class of the UE 105, a peak effective isotropic radiated power (EIRP) angle (i.e., best signal transmit direction) of the UE 105, an EIRP at the peak angle (sometimes referred to as peak EIRP) of the UE 105, an EIRP spherical coverage of the UE 105, and/or the like. Further details of the RF transmit characteristics are described below.

FIG. 1B depicts RF transmit characteristics of different UEs 105 in a summary table of the main RF transmit attributes specified by the 3GPP for new radio (NR) frequency range 2 (FR2) UE power classes. As shown, the RF transmit characteristics may include data identifying the power classes of the different UEs 105 and example UEs 105 for each power class. For example, a first power class (PC1) may be associated with FWA UEs 105, such as broadband FWA UEs with customer premises equipment (CPE) devices. The second power class (PC2) may be associated with vehicular UEs 105, such as cellular-vehicle-to-everything (C-V2x) UEs with onboard devices. The third power class (PC3) may be associated with handheld UEs 105, such as smartphones. The fourth power class (PC4) may be associated with high power non-handheld UEs 105 (HPUEs), such as onboard devices of high-speed trains.

As further shown in FIG. 1B, the RF transmit characteristics may include data identifying a minimum peak EIRP for a first frequency (e.g., n261 (28 gigahertz (GHz)) and a second frequency (e.g., n260 (39 GHz)). The first power class may be associated with a minimum peak EIRP of 40 decibel-milliwatts (dBm) for the first frequency and a minimum peak EIRP of 38 dBm for the second frequency. The second power class may be associated with a minimum peak EIRP of 29 dBm for the first frequency and may not be associated with a minimum peak EIRP for the second frequency. The third power class may be associated with a minimum peak EIRP of 22.4 dBm for the first frequency and a minimum peak EIRP of 20.6 dBm for the second frequency. The fourth power class may be associated with a minimum peak EIRP of 34 dBm for the first frequency and a minimum peak EIRP of 31 dBm for the second frequency.

As further shown in FIG. 1B, the RF transmit characteristics may include data identifying a maximum total radiated power (TRP) and a maximum EIRP. The first power class may be associated with a maximum TRP of 35 dBm and a maximum EIRP of 55 dBm. The second power class, the third power class, and fourth power each may be associated with a maximum TRP of 23 dBm and a maximum EIRP of 43 dBm.

As further shown in FIG. 1B, the RF transmit characteristics may include data identifying a spherical coverage for the first frequency (e.g., n261 (28 GHz) and the second frequency (e.g., n260 (39 GHz)). The first power class may be associated with a spherical coverage of 32 dBm at 85th percentile of the EIRP spatial cumulative distribution function (c.d.f.) for the first frequency and a spherical coverage of 30 dBm at 85%-ile for the second frequency. The second power class may be associated with a spherical coverage of 18 dBm at 60%-ile for the first frequency and may not be associated with a spherical coverage for the second frequency. The third power class may be associated with a spherical coverage of 11.5 dBm at 50%-ile for the first frequency and a spherical coverage of 8 dBm at 50%-ile for the second frequency. The fourth power class may be associated with a spherical coverage of 25 dBm at 20%-ile for the first frequency and a spherical coverage of 19 dBm at 20%-ile for the second frequency.

As shown in FIG. 1C, and by reference number 130, the management system 115 may calculate a signal range of the UE 105 based on the UE data, the network data, and the RF transmit characteristics of the UE 105. For example, a link budget is an accounting of all power gains and losses that a communication signal experiences in a telecommunication system, from the UE 105, through a communication medium such as radio waves, to the base stations 110. A simple link budget equation may have the form: received power=transmit power+gains−losses. A path loss is a reduction in power density that occurs as a radio wave propagates over a distance. Besides transmit power, another factor affecting range is receiver sensitivity. A maximum path loss may be calculated based on the receiver sensitivity as follows: maximum path loss=transmit power−receiver sensitivity+gains−losses. A signal range (e.g., in kilometers) may be calculated based on the maximum path loss, as follows:

Signal range=10^{(maximum path loss-32.44-20 log(f))/20},

where f is frequency in megahertz (MHz).

In some implementations, an estimated signal range of the UE 105 may include a two-dimensional or a three-dimensional array that may be overlayed on a two-dimensional or a three-dimensional representation of the private network. The management system 115 may further utilize the target QoS of a use case to calculate the signal range of the UE 105. For example, for a smart vision use case requiring a target QoS defined as a minimum uplink throughput of thirty (30) megabits per second (Mbps), the target QoS is an important input because it may significantly reduce the signal range of the UE 105 compared to a basic web browsing use case or a voice call use case.

In some implementations, the management system 115 may calculate signal ranges of the UE 105, in different directions, based on the UE data, the network data, and the RF transmit characteristics of the UE 105. The signal ranges may be different in the different directions due to the location (i.e., coordinates) and position (i.e., azimuth and tilt) of the UE 105 in relation to the locations of the base stations 110, and based on the RF transmit characteristics of the UE 105 including the EIRP spherical coverage characteristic (i.e., antenna pattern). If only coarser RF transmit characteristics of the UE 105 are known, such as the UE power class and the TRP, some extrapolation may be used to estimate some of the unknown parameters, such as the peak angle and the EIRP at peak angle, of the UE 105, based on the knowledge of similar devices.

As shown in FIG. 1D, and by reference number 135, the management system 115 may generate a programing and user interface based on the UE data, the network data, and the signal range of the UE 105. For example, the management system 115 may generate a programing and user interface (e.g., a two-dimensional or three-dimensional UE signal range overlayed in a two-dimensional or three-dimensional network representation) that includes a region (e.g., a floor plan, a geographic region, and/or the like), a representation of the location and orientation of the UE 105 (e.g., an icon of the manufacturing robot UE 105) that is based on the UE data, representations of the locations of the base stations 110 (e.g., icons of the base stations 110) that are based on the network data, and a representation of the signal range of the UE 105 relative to the locations of the UE 105 and the base stations 110. FIG. 1D provides an example of the programing and user interface. As shown, the signal range of the UE 105 may not reach the second base station 110-2 but may reach the first base station 110-1 and provide connectivity to the UE 105. Although FIG. 1D depicts the signal range of the UE 105 as a two-dimensional shape in a two-dimensional representation of the private network, in some implementations, the management system 115 may depict the signal range of the UE 105 as a three-dimensional shape in a three-dimensional representation of the private network.

As further shown in FIG. 1D, and by reference number 140, the management system 115 may provide the programing and user interface for display. For example, the management system 115 may provide the programing and user interface for display to a user of the management system 115, to a user device (e.g., a desktop computer, a laptop computer, a tablet computer, and/or the like) associated with a user of the management system 115, and/or the like. The programing and user interface may enable the user (e.g., an administrator) to determine in a visual way how to position (e.g., via location, azimuth and tilt) the UE 105 so that the UE 105 satisfies a target QoS within the region. The user may utilize the programing and user interface to position the UE 105 in the region in a way that takes into consideration the RF transmit characteristics of the UE 105 and the QoS requirements associated with the UE 105. In some implementations, the management system 115 may automatically determine how to position the UE 105 so that the UE 105 satisfies a target QoS within the region, and may cause the UE 105 to reposition in the region (e.g., by providing to the UE 105 an instruction to move to new 2D or 3D coordinates and to change its orientation to a new azimuth and/or tilt).

In some implementations, the user of the management system 115 may provide, to the management system 115 and via the programing and user interface, an instruction to reposition the UE 105 in the region. The management system 115 may receive the instruction, and may cause the UE 105 to move from the location to another location and to change its orientation based on the instruction.

In some implementations, and if permitted by the hardware design of the UE, the user of the management system 115 may provide, to the management system 115 and via the programing and user interface, an instruction to modify one or more of the RF transmit characteristics (e.g., a power class, and/or the like) of the UE 105. The management system 115 may receive the instruction, and may cause the UE 105 to modify the one or more RF transmit characteristics of the UE 105 based on the instruction. For example, the management system 115 may provide, to the UE 105, a command to modify the one or more RF transmit characteristics of the UE 105, e.g., in the form of a new information element in an RRC Reconfiguration message from the gNB to the UE, or an application-layer message from the management system to the UE. Thus, the UE 105 may modify the one or more RF transmit characteristics based on the command. In the case of an RRC command, the service interruption time is expected to be minimal since the UE can carry on connectivity with the gNB. In the case of an application-layer command (e.g., based on the Open Mobile Alliance Device Management (OMA DM) protocol), the service interruption time is expected to be longer, due to e.g., a need to shut down and wake up the UE with a new power class. The UE 105 may perform a tracking area update or registration update to let the network know about its new UE power class.

As shown in FIG. 1E, and by reference number 145, the management system 115 may process the UE data, the network data, the signal range of the UE 105, and certain triggers, with a model (e.g., a machine learning model), to determine whether to modify the RF transmit characteristics of the UE 105. For example, the UE 105 may be compliant with more than one power class for certain RF bands (e.g., the third power class and fourth power class in FIG. 1B). The triggers may include a change in the QoS associated with the UE 105, a change in the line of sight condition to one or more base stations 110 that the UE 105 is communicating with (e.g., due to moving obstacles), a trigger based on a change in the path loss (determined based on e.g., a change in the downlink RSRP measured by the UE 105), a trigger based on a change in the uplink interference (determined based on e.g., the uplink SINR measured by the base stations 110 in relation with the signal from the UE 105), a trigger based on a presence of humans within a predetermined distance from the UE 105, and/or the like.

In some implementations, the management system 115 may process the UE data, the network data, the signal range of the UE 105, and the triggers, with the model, to determine that the RF transmit characteristics of the UE 105 should be modified. Alternatively, the management system 115 may process the UE data, the network data, the signal range of the UE 105, and the triggers, with the model, to determine that the RF transmit characteristics of the UE 105 should not be modified. In such situations, the management system 115 may do nothing since the RF transmit characteristics of the UE 105 should be maintained. For example, the presence of humans within a predetermined distance from the UE 105 may prevent the power class of the UE 105 from being switched to the fourth power class (e.g., the high power non-handheld UE power class).

In some implementations, the management system 115 may process capabilities of a targeted base station 110, a target QoS (e.g., minimum uplink throughput, maximum latency, etc.) associated with the UE 105 to fulfill a specific use case, a peak transmit angle of the UE 105 and an EIRP at the peak beam angle, an UL SINR at the base station receiver needed to achieve the target QoS, uplink interference from other UEs 105 and/or base stations 110, and/or the like, with the model, to calculate the two-dimensional or three-dimensional signal range for the UE 105 discussed earlier herein.

As shown in FIG. 1F, and by reference number 150, the management system 115 may process the UE data, the network data, the signal range of the UE 105, and the triggers, with a model (e.g., a model based on deterministic algorithms, machine learning, and/or a combination of such approaches), to determine whether and how to reposition the UE 105. Alternatively, the management system 115 may process the UE data, the network data, the signal range of the UE 105, and the triggers, with a model, to determine that UE 105 should not be repositioned.

In some implementations, in addition to repositioning, the management system 115 may perform other actions based on processing the UE data, the network data, the signal range of the UE 105, and the triggers with a model. For example, the management system 115 may allocate a new UE 105 with a more suitable set of RF characteristics, may switch the UE 105 to a different set of RF characteristics, and/or the like.

As shown in FIG. 1G, and by reference number 155, the management system 115 may cause the UE 105 to modify the RF transmit characteristics of the UE 105, may cause the UE 105 to reposition, or may allocate a new UE 105. In some implementations, the management system 115 may allocate a new UE 105 with a more suitable set of RF characteristics. In some implementations, when causing the UE 105 to reposition, the management system 115 may provide, to the UE 105, an instruction to move to new coordinates and change its orientation. The UE 105 may receive the instruction from the management system 115, and may move to the new coordinates based on the instruction.

While in many use cases expected in private networks the uplink (UL) is typically the constraining factor of the link budget, there could be use cases where the downlink (DL) is limiting, due to e.g., a very high downlink throughput QoS requirement when compared to the uplink throughput QoS requirement. Thus, in some implementations, the RF receive characteristics of the UE 105, a DL SINR level at the UE receiver needed to achieve the target QoS, a transmit power of the base stations 110, downlink interference from other UEs 105 and/or base stations 110, and/or the like, may be additionally used to calculate the signal range of the UE discussed earlier herein. The RF receive characteristics of the UE 105 may include a peak receive angle, an equivalent isotropic sensitivity (EIS) at the peak angle (sometimes referred to as reference sensitivity power level), and/or an EIS spherical coverage. The triggers to determine whether another UE should be allocated, the RF characteristics of the UE should be modified, or the UE should be repositioned described earlier herein, may additionally include a change in the downlink interference (determined based on e.g., the downlink SINRs measured by the UE 105 in relation with the base stations 110).

In this way, the management system 115 allocates and positions a UE in a private network based on RF transmit characteristics. For example, the management system may allocate and position a UE 105 with different power classes in private networks, enterprise networks, industrial networks, and/or the like. The management system 115 may manage a UE 105 that is compliant with two or more UE power classes for added flexibility, and may generate a programing and user interface that provides a representation of a signal range of a UE 105 in relation to network devices (e.g., base stations 110). The management system 115 may relocate a UE 105 and/or modify RF transmit characteristics of the UE 105 based on the signal range of the UE 105, application needs, UL interference at the base station 110 receiver associated with the UE 105, proximity of the UE 105 to humans, and/or the like. Thus, the management system 115 may conserve computing resources, networking resources, and/or other resources that would have otherwise been consumed due to providing a poor service for the targeted use case(s) in a serving cell of the base station 110 or in portions of the serving cell, dispatching technicians to service the base station 110, unnecessarily modifying parameters of the base station 110, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

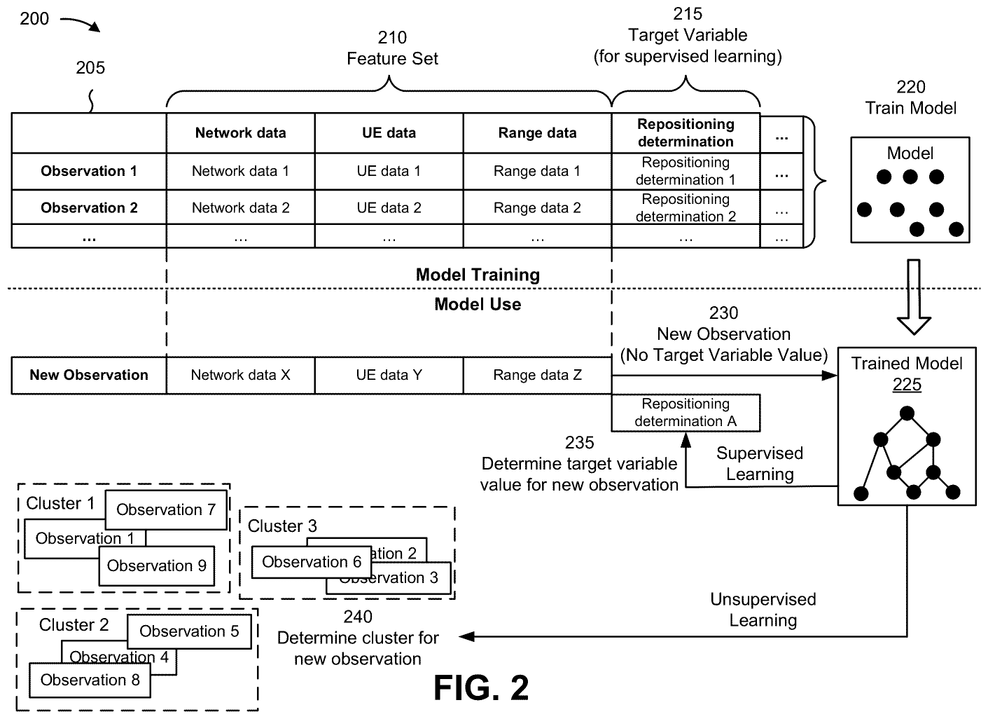

FIG. 2 is a diagram illustrating an example 200 of training and using a machine learning model to allocate and position a UE in a private network based on RF transmit characteristics. The machine learning model training and usage described herein may be performed using a machine learning system. The machine learning system may include or may be included in a computing device, a server, a cloud computing environment, and/or the like, such as the management system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the management system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the management system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of network data, a second feature of UE data, a third feature of range data, and so on. As shown, for a first observation, the first feature may have a value of network data 1, the second feature may have a value of UE data 1, the third feature may have a value of range data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be labelled “repositioning determination” and may include a value of “repositioning determination 1” for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of network data X, a second feature of UE data Y, a third feature of range data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of repositioning determination A for the target variable of the repositioning determination for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a network data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a UE data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to allocate and position a UE in a private network based on RF transmit characteristics. The machine learning system enables recognition and/or identification of tens, hundreds, thousands, or millions of features and/or feature values for tens, hundreds, thousands, or millions of observations, thereby increasing accuracy and consistency and reducing delay associated with allocating and positioning a UE in a private network based on RF transmit characteristics relative to requiring computing resources to be allocated for tens, hundreds, or thousands of operators to manually allocate and position a UE in a private network based on RF transmit characteristics.

As indicated above, FIG. 2 is provided as an example. Other examples may differ from what is described in connection with FIG. 2.

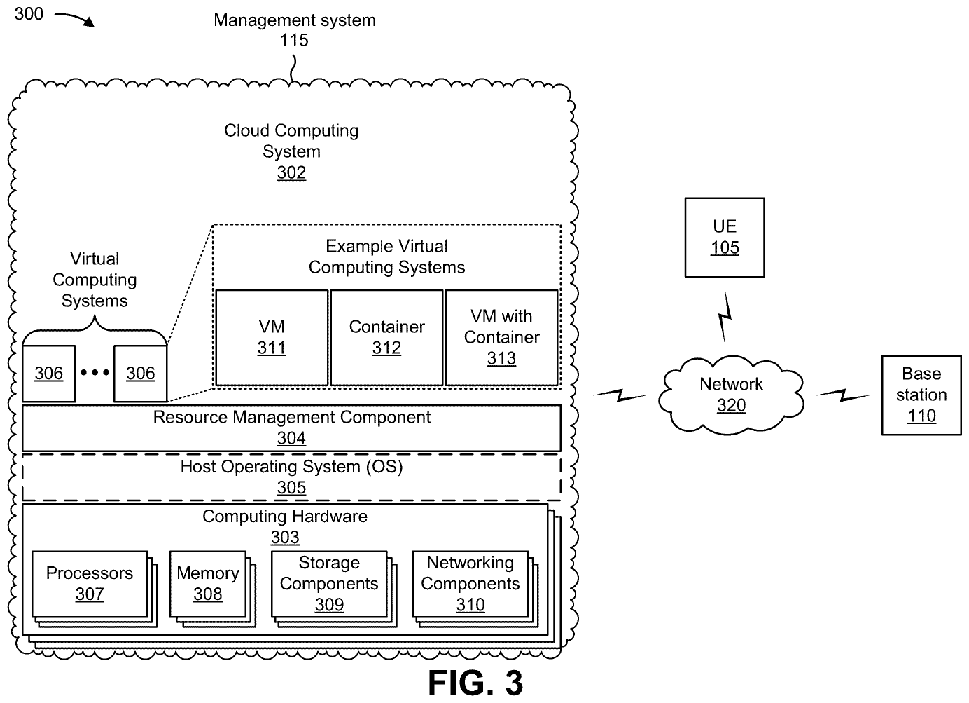

FIG. 3 is a diagram of an example environment 300 in which systems and/or methods described herein may be implemented. As shown in FIG. 3, the environment 300 may include the management system 115, which may include one or more elements of and/or may execute within a cloud computing system 302. The cloud computing system 302 may include one or more elements 303-313, as described in more detail below. As further shown in FIG. 3, the environment 300 may include the UE 105, the base station 110, and/or a network 320. Devices and/or elements of the environment 300 may interconnect via wired connections and/or wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, an HPUE, or a similar type of device.

The base station 110 includes one or more devices capable of transferring traffic, such as audio, video, text, and/or other traffic, destined for and/or received from a UE. For example, the base station 110 may include an eNodeB (eNB) associated with a long term evolution (LTE) network that receives traffic from and/or sends traffic to a core network, a gNodeB (gNB) associated with a RAN of a fifth generation (5G) network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 110 may support, for example, a cellular radio access technology (RAT). The base station 110 may transfer traffic between a UE (e.g., using a cellular RAT), one or more other base stations 110 (e.g., using a wireless interface or a backhaul interface, such as a wired backhaul interface), and/or a core network. The base station 110 may provide one or more cells that cover geographic areas.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication interface) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

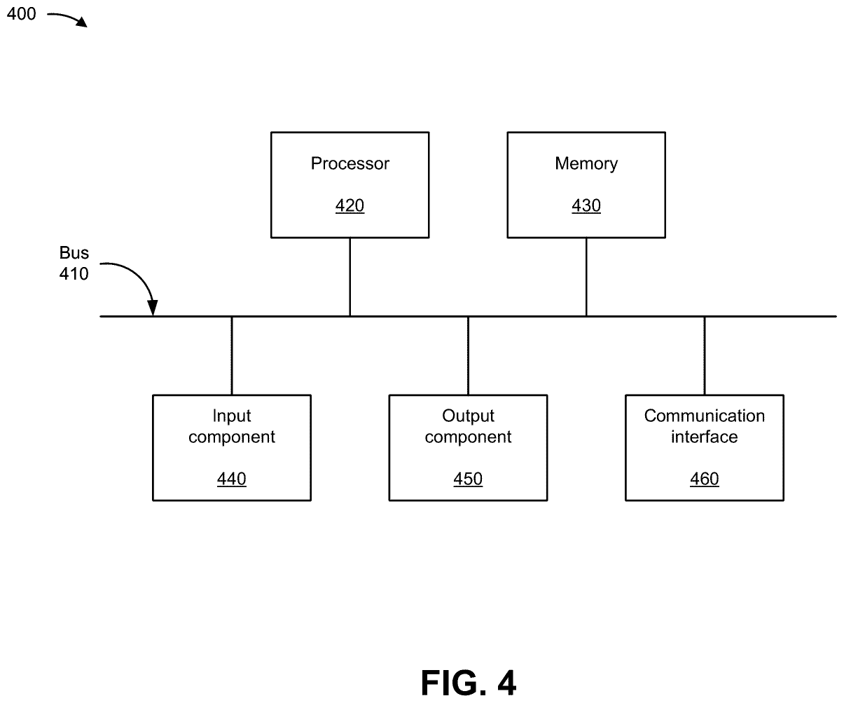

Although the management system 115 may include one or more elements 303-313 of the cloud computing system 302, may execute within the cloud computing system 302, and/or may be hosted within the cloud computing system 302, in some implementations, the management system 115 may not be cloud-based (e.g., may be implemented outside of a cloud computing system) or may be partially cloud-based. For example, the management system 115 may include one or more devices that are not part of the cloud computing system 302, such as the device 400 of FIG. 4, which may include a standalone server or another type of computing device. The management system 115 may perform one or more operations and/or processes described in more detail elsewhere herein.

The network 320 may include one or more wired and/or wireless networks. For example, the network 320 may include a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 320 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the UE 105, the base station 110, and/or the management system 115. In some implementations, the UE 105, the base station 110, and/or the management system 115 may include one or more devices 400 and/or one or more components of the device 400. As shown in FIG. 4, the device 400 may include a bus 410, a processor 420, a memory 430, an input component 440, an output component 450, and a communication interface 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication interface 460 enables the device 400 to communicate with other devices via a wired connection and/or a wireless connection. For example, the communication interface 460 may include a receiver, a transmitter, a transceiver, a modem, a network interface card, an antenna, and/or one or more RF receive/transmit chains (e.g., power amplifiers, filters, RF frequency convertors, antenna arrays, and/or the like). The communication interface 460 may include one or more RF Rx/Tx chains which play a role in determining the RF characteristics of the UE 105, as described above.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

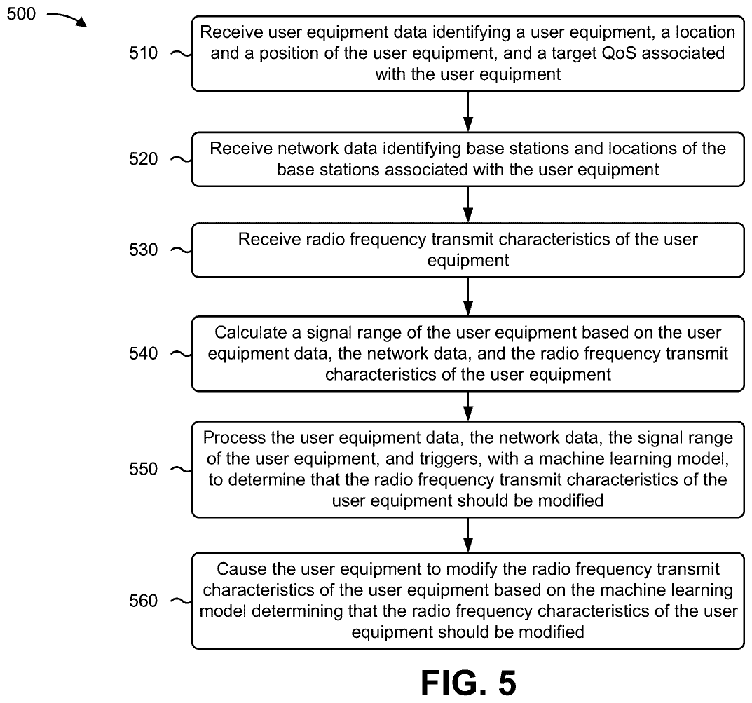

FIG. 5 is a flowchart of an example process 500 for changing the RF transmit and receive characteristics of a UE in a private network. In some implementations, one or more process blocks of FIG. 5 may be performed by a device (e.g., the management system 115). In some implementations, one or more process blocks of FIG. 5 may be performed by another device or a group of devices separate from or including the device, such as a base station (e.g., the base station 110) and/or a UE (e.g., the UE 105). Additionally, or alternatively, one or more process blocks of FIG. 5 may be performed by one or more components of the device 400, such as the processor 420, the memory 430, the input component 440, the output component 450, and/or the communication interface 460.

As shown in FIG. 5, process 500 may include receiving UE data identifying a UE, a location and a position of the UE, and a target QoS associated with the UE (block 510). For example, the device may receive UE data identifying a UE, a location and a position of the UE, and a target QoS associated with the UE as described above. In some implementations, the UE is assumed to be compliant per hardware design with one or more UE power classes, such as fixed wireless access UE, vehicular UE, handheld UE, or high power non-handheld UE power classes.

As further shown in FIG. 5, process 500 may include receiving network data identifying base stations and locations of the base stations associated with the UE (block 520). For example, the device may receive network data identifying base stations and locations of the base stations associated with the UE, as described above.

As further shown in FIG. 5, process 500 may include receiving RF transmit characteristics of the UE (block 530). For example, the device may receive RF transmit characteristics of the UE, as described above. In some implementations, the RF transmit characteristics of the UE include one or more of a power class of the UE, a TRP of the UE, a peak EIRP angle of the UE, a peak EIRP of the UE, an EIRP spherical coverage of the UE, a peak EIS of the UE, and/or the likes.

As further shown in FIG. 5, process 500 may include calculating a signal range of the UE based on the UE data, the network data, and the RF transmit characteristics of the UE (block 540). For example, the device may calculate a signal range of the UE based on the UE data, the network data, and the RF transmit characteristics of the UE, as described above.

As further shown in FIG. 5, process 500 may include processing the UE data, the network data, the signal range of the UE, and triggers, with a machine learning model, to determine that the RF transmit characteristics of the UE should be modified (block 550). For example, the device may process the UE data, the network data, the signal range of the UE, and triggers, with a machine learning model, to determine that the RF transmit characteristics of the UE should be modified, as described above. In some implementations, the triggers include one or more of a change in the quality of service associated with the UE, a change to the line of sight condition to one or more of the base stations that the UE is communicating, a trigger based on a change in the uplink and/or downlink interference measured by the base stations and/or the UE respectively, or a trigger based on a presence of humans within a predetermined distance from the UE.

As further shown in FIG. 5, process 500 may include causing the UE to modify its RF transmit characteristics based on the machine learning model determining that the RF transmit characteristics of the UE should be modified (block 560). For example, the device may cause the UE to modify the RF transmit characteristics of the UE based on the machine learning model determining that the RF transmit characteristics of the UE should be modified, as described above.

In some implementations, process 500 includes generating a programing and user interface based on the UE data, the network data, and the signal range of the UE, and providing the programing and user interface for display. In some implementations, the programing and user interface includes a representation of the location of the UE, a representation of the signal range of the UE, and representations of the locations of the base stations.

In some implementations, process 500 includes receiving an instruction to modify the RF transmit characteristics of the UE based on providing the programing and user interface for display to a user such as a network administrator, and the user causing the UE to modify its RF transmit characteristics.

In some implementations, process 500 includes receiving additional UE data identifying another UE; receiving additional network data identifying base stations associated with the other UE; receiving other RF transmit characteristics of the other UE; calculating another signal range of the other UE based on the additional UE data, the additional network data, and the additional RF transmit characteristics of the other UE; and processing the additional UE data, the additional network data, the other signal range of the other UE, and the triggers, with the machine learning model, to determine that the other RF transmit characteristics of the UE should be maintained.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

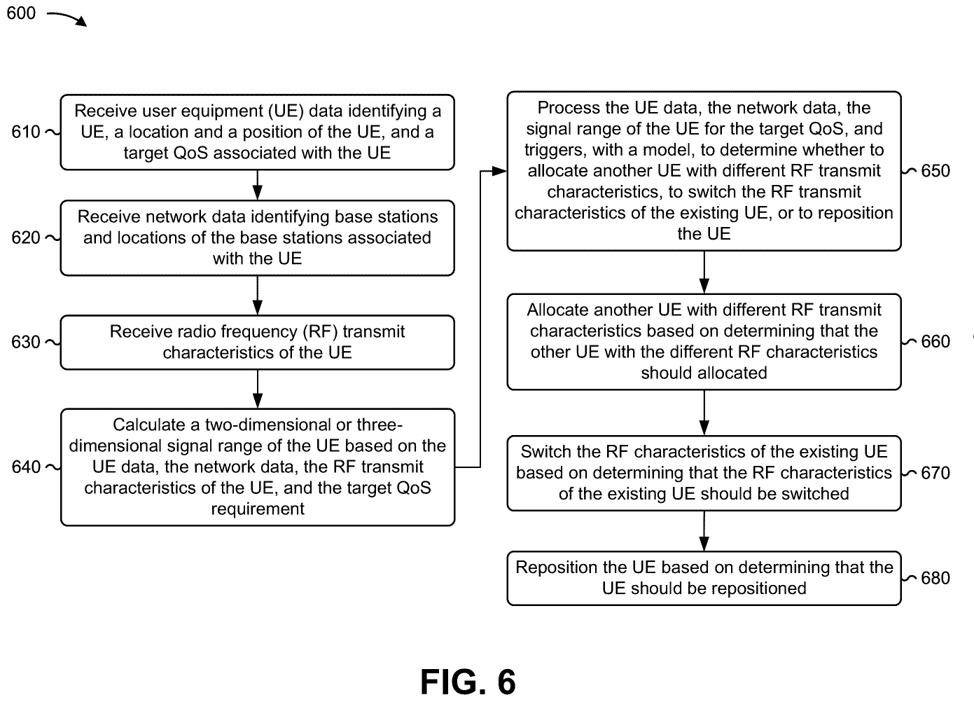

FIG. 6 is a flowchart of a more generic example process 600 with additional detail for allocating a UE in a private network, switching RF transmit and receive characteristics of the UE, and positioning the UE in the private network based on the RF transmit and receive characteristics. In some implementations, one or more process blocks of FIG. 6 may be performed by a device (e.g., the management system 115). In some implementations, one or more process blocks of FIG. 6 may be performed by another device or a group of devices separate from or including the device, such as a base station (e.g., the base station 110) and/or a UE (e.g., the UE 105). Additionally, or alternatively, one or more process blocks of FIG. 6 may be performed by one or more components of the device 400, such as the processor 420, the memory 430, the input component 440, the output component 450, and/or the communication interface 460.

As shown in FIG. 6, process 600 may include receiving user equipment data identifying a user equipment, a location and a position of the user equipment, and a target QoS associated with the user equipment (block 610). For example, the device may receive user equipment data identifying a user equipment, a location and a position of the user equipment, and a target QoS associated with the user equipment, as described above.

As further shown in FIG. 6, process 600 may include receiving network data identifying base stations and locations of the base stations associated with the user equipment (block 620). For example, the device may receive network data identifying base stations and locations of the base stations associated with the user equipment, as described above.

As further shown in FIG. 6, process 600 may include receiving radio frequency transmit characteristics of the user equipment (block 630). For example, the device may receive radio frequency transmit characteristics of the user equipment, as described above.

As further shown in FIG. 6, process 600 may include calculating a two-dimensional or three-dimensional signal range of the user equipment based on the user equipment data (includes the QoS requirement), the network data, the radio frequency transmit characteristics of the user equipment (block 640). For example, the device may calculate a two-dimensional or three-dimensional signal range of the user equipment based on the user equipment data, the network data, and the radio frequency transmit characteristics of the user equipment, as described above.

As further shown in FIG. 6, process 600 may include processing the UE data, the network data, the signal range of the UE for the target QoS, and triggers, with a model, to determine whether to allocate another UE with different RF transmit characteristics, to switch the RF transmit characteristics of the existing UE, or to reposition the UE (block 650). For example, the device may process the UE data, the network data, the signal range of the UE for the target QoS, and triggers, with a model (e.g., a model based on deterministic algorithms, a machine learning model, and/or the like), to determine whether to allocate another UE with different RF transmit characteristics, to switch the RF transmit characteristics of the existing UE, or to reposition the UE, as described above.

As further shown in FIG. 6, process 600 may include allocating another UE with different RF transmit characteristics based on determining that the other UE with the different RF characteristics should allocated (block 660). For example, the device may allocate another UE with different RF transmit characteristics based on determining that the other UE with the different RF characteristics should allocated, as described above.

As further shown in FIG. 6, process 600 may include switching the RF characteristics of the existing UE based on determining that the RF characteristics of the existing UE should be switched (block 670). For example, the device may switch the RF characteristics of the existing UE based on determining that the RF characteristics of the existing UE should be switched, as described above.

As further shown in FIG. 6, process 600 may include repositioning the UE based on determining that the UE should be repositioned (block 680). For example, the device may reposition the UE based on determining that the UE should be repositioned, as described above.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, user equipment data identifying a user equipment, a location and a position of the user equipment, and a target quality of service associated with the user equipment;
receiving, by the device, network data identifying base stations and locations of the base stations associated with the user equipment;
receiving, by the device, radio frequency transmit characteristics of the user equipment;
calculating, by the device, a signal range of the user equipment based on the user equipment data, the network data, and the radio frequency transmit characteristics of the user equipment;
processing, by the device, the user equipment data, the network data, the signal range of the user equipment, and triggers, with a model, to determine that the radio frequency transmit characteristics of the user equipment should be modified; and
causing, by the device, the user equipment to modify the radio frequency transmit characteristics of the user equipment based on the model determining that the radio frequency transmit characteristics of the user equipment should be modified.

2. The method of claim 1, further comprising:
generating a programing and user interface based on the user equipment data, the network data, and the signal range of the user equipment; and
providing the programing and user interface for display.

3. The method of claim 2, wherein the programing and user interface includes a representation of the location of the user equipment, a representation of the signal range of the user equipment, and representations of the locations of the base stations.

4. The method of claim 2, further comprising:
receiving an instruction to reposition the user equipment based on providing the programing and user interface for display; and
causing the user equipment to reposition from the location to another location based on the instruction.

5. The method of claim 2, further comprising:
receiving an instruction to modify the radio frequency transmit characteristics of the user equipment based on providing the programing and user interface for display; and
causing the user equipment to modify the radio frequency transmit characteristics of the user equipment based on the instruction.

6. The device of claim 1, wherein the radio frequency transmit characteristics of the user equipment include one or more of:
a power class of the user equipment,
a total radiated power of the user equipment,
a peak effective isotropic radiated power (EIRP) angle of the user equipment,
a peak EIRP of the user equipment,
an EIRP spherical coverage of the user equipment, or
a peak effective isotropic sensitivity of the user equipment.

7. The method of claim 1, wherein causing the user equipment to modify the radio frequency transmit characteristics of the user equipment comprises:
causing the user equipment to switch to a new power class via a radio resource control reconfiguration message from the base station, or
causing the user equipment to switch to a new power class via an application-layer command from the management system.

8. A device, comprising:
one or more processors configured to:
receive user equipment data identifying a user equipment, a location and a position of the user equipment, and a target quality of service associated with the user equipment;
receive network data identifying base stations and locations of the base stations associated with the user equipment;
receive radio frequency transmit characteristics that identify one or more of a power class of the user equipment, a total radiated power of the user equipment, a peak effective isotropic radiated power (EIRP) angle of the user equipment, a peak EIRP of the user equipment, an EIRP spherical coverage of the user equipment, or a peak effective isotropic sensitivity of the user equipment;
calculate a signal range of the user equipment based on the user equipment data, the network data, and the radio frequency transmit characteristics of the user equipment;
process the user equipment data, the network data, the signal range of the user equipment, and triggers, with a model, to determine that the radio frequency transmit characteristics of the user equipment should be modified; and
cause the user equipment to modify the radio frequency transmit characteristics of the user equipment based on the model determining that the radio frequency transmit characteristics of the user equipment should be modified.

9. The device of claim 8, wherein the one or more processors are further configured to:
receive additional user equipment data identifying another user equipment;
receive additional network data identifying base stations associated with the other user equipment;
receive other radio frequency transmit characteristics of the other user equipment;
calculate another signal range of the other user equipment based on the additional user equipment data, the additional network data, and the other radio frequency transmit characteristics of the other user equipment; and
process the additional user equipment data, the additional network data, the other signal range of the other user equipment, and the triggers, with the model, to determine that the other radio frequency transmit characteristics of the user equipment should be maintained.

10. The device of claim 8, wherein the one or more processors are further configured to:
process the user equipment data, the network data, the signal range of the user equipment, and the triggers, with the model, to determine that the user equipment is to be repositioned; and
cause the user equipment to reposition from the location to another location based on the model determining to reposition the user equipment.

11. The device of claim 8, wherein the one or more processors are further configured to:
process the user equipment data, the network data, the signal range of the user equipment, and the triggers, with the model, to determine that the user equipment is not to be repositioned; and
cause the user equipment to remain at the location based on the model determining to not reposition the user equipment.

12. The device of claim 8, wherein the one or more processors, to cause the user equipment to modify the radio frequency transmit characteristics of the user equipment, are configured to:
cause the user equipment to shut down and wake up with a new power class.

13. The device of claim 8, wherein the triggers include one or more of:
a change in a quality of service associated with the user equipment,
a change in the line of sight condition to one or more base stations that the user equipment is communicating with,
a change in the path loss,
a change in the uplink or downlink interference, or
a presence of humans within a predetermined distance from the user equipment.

14. The device of claim 8, wherein the user equipment includes one or more of:
a handheld user equipment,
a wearable user equipment,
a manufacturing robot user equipment,
an automated guided vehicle user equipment,
a cellular router user equipment,
a sensor user equipment,
and/or the likes.

15. A non-transitory computer-readable medium storing a set of instructions, the set of instructions comprising:
one or more instructions that, when executed by one or more processors of a device, cause the device to:
receive user equipment data identifying a user equipment, a location and a position of the user equipment, and a target quality of service associated with the user equipment;
receive network data identifying base stations and locations of the base stations associated with the user equipment;
receive radio frequency transmit characteristics of the user equipment;
calculate a signal range of the user equipment based on the user equipment data, the network data, and the radio frequency transmit characteristics of the user equipment;
process the user equipment data, the network data, the signal range of the user equipment, and triggers, with a model, to determine whether the radio frequency transmit characteristics of the user equipment are to be modified; and
cause the user equipment to modify the radio frequency transmit characteristics of the user equipment based on the model determining that the radio frequency transmit characteristics of the user equipment are to be modified; or
cause the user equipment to maintain the radio frequency transmit characteristics of the user equipment based on the model determining that the radio frequency transmit characteristics of the user equipment are not to be modified.

16. The non-transitory computer-readable medium of claim 15, wherein the one or more instructions further cause the device to:
generate a programing and user interface based on the user equipment data, the network data, and the signal range of the user equipment;
provide the programing and user interface for display;
receive an instruction to reposition the user equipment based on providing the programing and user interface for display; and
cause the user equipment to reposition from the location to another location based on the instruction.

17. The non-transitory computer-readable medium of claim 16, wherein the one or more instructions further cause the device to:
receive an instruction to modify the radio frequency transmit characteristics of the user equipment based on providing the programing and user interface for display to a user; and
cause the user equipment to modify the radio frequency transmit characteristics of the user equipment based on the instruction.

18. The non-transitory computer-readable medium of claim 15, wherein the one or more instructions, that cause the device to cause the user equipment to modify the radio frequency transmit characteristics of the user equipment, cause the device to:
cause the user equipment to switch to a new power class via a radio resource control reconfiguration message from the base station, or
cause the user equipment to switch to a new power class via an application-layer command from the management system.

19. The non-transitory computer-readable medium of claim 15, wherein the one or more instructions further cause the device to:
process the user equipment data, the network data, the signal range of the user equipment, and the triggers, with the model, to determine whether to reposition the user equipment; and
cause the user equipment to reposition from the location to another location based on the model determining to reposition the user equipment; or
cause the user equipment to remain at the location based on the model determining to not reposition the user equipment.

20. The non-transitory computer-readable medium of claim 15, wherein the one or more instructions, that cause the device to cause the user equipment to modify the radio frequency transmit characteristics of the user equipment, cause the device to:
cause the user equipment to shut down and wake up with a new power class.
